(19) United States
(12) Patent Application Publication
(10) Pub. No.: US 2021/0130543 A1
(43) Pub. Date: May 6, 2021

(54) SYNTHESIS OF CYANURATE AND MULTIFUNCTIONAL ALCOHOL-BASED POLYETHER ACRYLATE FOR UV CURABLE MATERIALS

(71) Applicants: ZHONGSHUN YUAN, LONDON (CA); CHUNBAO XU, LONDON (CA); WEI WU, LONDON (CA)

(72) Inventors: ZHONGSHUN YUAN, LONDON (CA); CHUNBAO XU, LONDON (CA); WEI WU, LONDON (CA)

(21) Appl. No.: 17/085,218

(22) Filed: Oct. 30, 2020

Related U.S. Application Data
(60) Provisional application No. 62/927,876, filed on Oct. 30, 2019.

(51) Int. Cl. C08G 65/26; C08K 5/3492; C09D 171/08; C09J 171/08; C08K 5/00; B01J 27/135; B01J 31/02

(52) U.S. Cl. CPC C08G 65/2609; C08K 5/34924; C08G 65/2615; C08G 65/263; B01J 31/0225; C09D 171/08; C09J 171/08; C08K 5/005; B01J 27/135; C08G 65/2624

(57) ABSTRACT

Polyether (meth)acrylates based on cyanuric acid or substituted cyanuric acid and multifunctional alcohol, which optionally include triethanolamine units, have wide applications in UV curable adhesives, coatings, inks, sealants, paints or 3D printing. These polyether acrylates have rigid cyanurate structure endowing the material with extra strength and thermal stability. Furthermore, triethanolamine unit, when present, endows the material with anti-oxygen inhibition property in UV curing process. These polyether (meth)acrylates have low viscosity and high reactivity towards UV curing. The cured resins have high resilience and strength. The process of making the polyether (meth)acrylates includes the synthesis of trifunctional polyether polyols through controlled polymerization of propylene oxide using multifunctional alcohol (such as glycerol and sucrose), cyanuric acid or substituted cyanuric acid, and optionally triethanolamine, in the presence of a catalyst, followed by the synthesis of polyether (meth)acrylates through transesterification or through direct esterification of the trifunctional polyether polyols.

### FIELD

The present disclosure provides a method for the synthesis of cyanurate-multifunctional alcohol, polyether (meth)acrylate for UV curable materials.

### BACKGROUND

UV curing materials are widely used in inks, adhesives, paints, and coatings due to their fast cure rate, energy saving, and less or even no emission of volatile organic chemicals (VOC). Typical UV curable resins consist of oligomers, monomers (which act as diluents), photo-polymerization initiators, co-initiators (spectral sensitizer, reducing agents etc.) and various additives such as stabilizers, antioxidants, plasticizers, and pigments. The majority of commercial light curable resins are based on free radical curing acrylic compounds (acrylates). Free radical curing compositions are the most versatile curing systems in regard to product properties and monomers/oligomers available on the market.

At present, a large number of acrylic-functionalized oligomers presently commercially available are based on polyesters, epoxy resins, aliphatic and aromatic urethanes, and silicones. These polymers usually have a high viscosity, needing diluent to reduce the viscosity in order to facilitate surface spreading in coatings, inks and adhesives. Urethane acrylate oligomers as UV curable prepolymers are available in large quantities and can be synthesized through multi-step reactions of diisocyantes, hydroxylalkyl acrylates, and polyether based polyols through two approaches. In one approach the difunctional polyether polyol first reacts with two molecules of diisocyanate on each chain end to produce an isocyanate terminated polymer, after which the chain ends are capped with a hydroxy functional acrylate through direct addition.

The other approach is that one molecule of diisocyanate is first reacted with one molecule of hydroxy functional acrylate to produce a monomer with an isocyanate at one chain end and an acrylate at the other chain end, after which two moles of bifunctional monomers are reacted with one mole of bifunctional polyether polyol to produce acrylate terminated oligomer. The polyether based polyols are synthesized by ring opening polymerization of propylene oxide with multifunctional alcohol starting agents. Although there are some obvious advantages of using poly(propylene oxide) polyether, such as no coloration, good resilience, and easy spreading on surfaces due to low viscosity, poly(propylene oxide) polyether acrylate type of UV curing materials are not available due to the difficulty involved in their synthesis.

Polypropylene oxide polyols are widely used in the synthesis of polyurethane and other materials. The synthesis of poly(propylene oxide) polyols have been widely investigated, and are still a hot research area. Synthesis of low molecular weight multifunctional poly(propylene oxide) polyols (hydroxyl number 200 mgKOH/g) are mostly achieved by polymerizing propylene oxide with multifunctional polyol starting agents in the presence of alkaline catalysts mostly potassium hydroxide.

Synthesis of high molecular weight poly(propylene oxide) polyols are achieved by chain extension through ring opening polymerization of propylene oxide of the above polymer using double metal catalysts or other catalysts. Due to the softness of poly(propylene oxide) polyether, low molecular weight products are more suitable for the preparation of stiff and resilient materials such as coatings, adhesives, inks, 3D printing. High molecular weight poly(propylene oxide) polyether is more suitable for rubbery materials. To further increase the stiffness or mechanical strength, rigid starting agents may be used. Cyanuric acid is known for its rigid ring and good thermal stability and mechanical strength, and has been used for a variety of material construction. The excellent thermal and mechanical properties of isocyanurate based polypropylene oxide ether polyurethane materials were reported long time ago. 1,3,5-Tris(2-hydroxyethyl)cyanuric acid triacrylate (CAS No. 40220-08-4) are widely used as curing agent showing excellent thermal stability and chemical resistance. However, its high melting point restricts its wide application. Due to the insolubility of cyanuric acid, the synthesis of isocyanurate based poly(propylene oxide) polyols directly using cyanuric acid as starting material has not been reported.

Two main approaches are used to synthesize (meth)acrylate products: direct esterification of (meth)acrylic acid with alcohols and transesterification of low alcohol (meth)acrylates such as methyl (meth)acrylate or ethyl (meth)acrylate with higher alcohols. Both direct esterification and transesterification are equilibrium reactions. To shift the reaction towards high alcohol (meth)acrylate products, the byproducts of water and/or low alcohols must be removed from the reaction mixture either by azeotropic distillation using an azeotropic solvent or by adsorption with an absorbent. Both of these methods of direct esterification and transesterification methods work well with primary alcohols. However, secondary alcohols are much less reactive and tertiary alcohols are unreactive towards direct esterification and transesterification because of steric hindrance. Thus, higher reaction temperature and longer reaction time are needed for the synthesis of esters of secondary alcohols. (Meth)acrylic acid and esters are very temperature sensitive chemicals, liable to radical polymerization under long time heating. The inhibition of their auto radical polymerization has been a long time research topic, see (Chen. Eng. Technol. 2006, 29 (8), 931-936).

Polymerization can happen on the reactor wall, reflux condenser, and distillation column. There have been many accidents involved in these processes even related to the melting of glacial acrylic acid. The reaction conditions for the synthesis of various acrylates depends on the reactivity and properties of feedstock.

Ring opening polymerization of propylene oxide produces polyether polyols with mainly secondary alcohols at the chain end. Many researchers have attempted to synthesize poly(propylene oxide) acrylates through direct esterification or transesterification of polypropylene oxide polyols, but have not been successful due to the low reactivity of the secondary alcohols of polypropylene oxide and the likely radical polymerization of acrylic acid and polyether acrylates at elevated temperature for extended reaction time. Auto polymerization of acrylic acid and acrylates also frequently happened during experiments carried out by the present inventors. In the polyurethane industry, to increase the reactivity of poly(propylene oxide) polyol, ethylene oxide end capping is used to produce polyether polyols with high percentage of primary alcohol chain ends, but the end capping can only produce 85% primary alcohols at the chain ends, the 15% secondary alcohol still has difficulty in esterification. What is more, for low molecular weight poly(propylene oxide) polyether, end capping with poly(ethylene oxide) will greatly modify the properties of the polyether product to give unwanted high hydroscopic and crystalline characters. Although the synthesis of polyethylene glycol (meth)acrylates through direct esterification or transesterification of the primary alcohols in polyethylene oxide polyols are well documented, there are some limitations in applications of the hydroscopic and crystalline polyethylene oxide.

### SUMMARY

The present disclosure provides a method for synthesis of cyanurate-glycerol polyether acrylate for UV curable materials.

The present disclosure provides a multifunctional polyether polyol which is a polymerization product of:

cyanuric acid or substituted cyanuric acid,
multifunctional alcohol, and
propylene oxide.

The substituted cyanuric acid may be 1,3,5-Tris(2-hydroxyethyl)cyanuric acid.

The polyether polyol may have the following general formula:

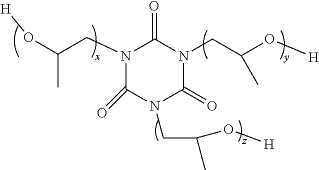

wherein each of x, y, and z is independently 1 to 20.

The multifunctional alcohol may be glycerol or sucrose.

The polymerization product may further include triethanolamine units.

The polyether polyol may have a molecular weight in a range from about 300 to about 2000 g/mol.

The present disclosure provides polymer which is an esterified product of (i) the polyether polyol and (ii) any one or a combination of acrylic acid, methacrylic acid, acrylate and methacrylate. The acrylate may be ethyl acrylate or methyl acrylate, and the methacrylate is methyl methacrylate or ethyl methacrylate.

The present disclosure provides a UV curable composition comprising these polymers. These UV curable compositions may be for use in any one of coatings, adhesives, paints, printing inks, and 3D printing.

The present disclosure provides a method of preparing a trifunctional polyether polyol, the method comprising:

mixing monomers in a reactor in the presence of a catalyst to obtain a mixture of the monomers, wherein the monomers in the mixture comprise cyanuric acid or substituted cyanuric acid, multifunctional alcohol, and propylene oxide; and

polymerizing the monomers in the reactor to produce the trifunctional polyether polyol.

The monomers may further comprise triethanolamine. The substituted cyanuric acid may be 1,3,5-Tris(2-hydroxyethyl)cyanuric acid.

The cyanuric acid or the substituted cyanuric acid may be present in the amount of about 0 to about 60 mol %, and the triethanolamine is in the range from about 0 to about 20 mol %.

The multifunctional alcohol may be glycerol or sucrose.

The catalyst may be an alkaline catalyst.

The alkaline catalyst may be potassium hydroxide or sodium hydroxide. The catalyst may be present in a concentration from about 0.1 to about 5 mol % of hydroxyl groups.

The multifunctional polyether polyol may be a trifuctional trifunctional polyether polyol. The concentration of the catalyst may be in a range from about 0.2 to about 3 mol % of hydroxyl groups.

The present disclosure provides a method of preparing a polyether polyol (meth)acrylate comprising:

adding the multifunctional polyether polyol according to the present disclosure into a reactor; and

reacting the trifunctional polyether polyol with an esterification agent in the presence of a catalyst, wherein the esterification agent is selected from the group consisting of acrylic acid, methacrylic acid, low alcohol acrylate, and low alcohol methacrylate.

The polyether polyol may be glycerol isocyanurate poly(propylene oxide) polyether polyol, glycerol-triethanolamine-isocyanurate poly(propylene oxide) polyether polyols, sucrose-glycerol poly(propylene oxide) polyether polyols, sucrose-glycerol-triethanolamine poly(propylene oxide) polyether polyols.

The esterification agent used in the reacting step may be low alcohol acrylate or low alcohol methacrylate, selected from the group consisting of methyl acrylate, ethyl acrylate, methyl methacrylate and ethyl methacrylate.

The catalyst may be titanium tetrachloride (TiCl₄) or titanium tetraiosproppoxide (TiTIP). The TiCl₄ may be present in a concentration of about 0.1 to about 2 wt % and TiTIP may be present in a concentration range from about 0.1 to about 2 wt %.

The method may further include a step of recycling the catalyst for a next reaction without sacrifice their activity.

The ratio of the esterification agent and hydroxyl groups in the polyether polyol may be about 1.0 to about 5.0:1. The ratio may be about 1.2 to about 2.5:1.

The method may further comprise adding a solvent wherein the solvent is any one or a combination of a hydrocarbon solvent and an ether solvent. The hydrocarbon solvent may be any one of hexanes, cyclohexane, heptane, octane and toluene, and the ether solvent is any one of dioxane, dimethyl ethylene glycol ether, diethyl ethylene glycol ether, and dimethyl propylene glycol ether.

The method may further comprise a step of removing by-product methanol or ethanol. This removing step may be carried out using molecular sieves or azeotropic distillation.

The method may further comprise a step of adding an inhibitor for polymerization of the esterification agents. The inhibitor may be any one or a combination of phenothiazine, methyl hydroquinone (MEDQ), diethylhydroxylamine and nitrosobenzene.

The esterification agent used in the reacting step may be acrylic acid or methacrylic acid. The catalyst may be organosulfonic acid. This organosulfonic acid may be any one of toluenesulfonic acid, methanesulfonic acid, and sulfonic based ionic exchange resins. The toluenesulfonic acid or the mathanesulfonic acid may be added in a concentration range from about 0.1 to about 3 wt %. The sulfonic based ionic exchange resins may be added in a concentration from about 2 to about 30 wt %.

The method may further comprise a step of adding a polymerization inhibitor and/or a water-azeotropic solvent. This polymerization inhibitor may be a phenolic antioxidant or phenothiazine. The phenolic antioxidant may be methyl hydroquinone (MEHQ) or butylate hydroxytoluene (BHT).

The phenolic antioxidant may be added in a concentration range of about 100 to about 10,000 ppm and the phenothiazine may be added in a concentration of about 100 to about 5,000 ppm.

The polymerization inhibitor may be added to a Dean Stark to prevent advent polymerization on a fractional column.

The solvent may be any one or a combination of a hydrocarbon and chlorinate hydrocarbon. The hydrocarbon may be a hexane, a cyclohexane or a heptane, and the chlorinate hydrocarbon may be 1,2-dichloroethane, 1,1-dichlorethane or chloroform.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1A is an Fourier Transform Infrared (FTIR) spectrum of cyanuric polyether polyol;

FIG. 1B is an Fourier Transform Infrared (FTIR) spectrum of cyanuric polyether acrylate.

FIG. 2A is an NMR spectra of polyether; and

FIG. 2B is an NMR spectra of polyether acrylate.

### DETAILED DESCRIPTION

Various embodiments and aspects of the disclosure will be described herein with reference to details discussed below. The following description and drawings are illustrative of the disclosure and are not to be construed as limiting the disclosure. The drawings are not to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the terms “about” and “approximately” are meant to cover variations that may exist in the upper and lower limits of the ranges of values, such as variations in properties, parameters, and dimensions.

Disclosed herein is a method for the synthesis of cyanurate-multifunctional alcohol based, especially cyanurate-glycerol polyether (meth)acrylate and isocyanurate-glycerol-triethanolamine polyether (meth)acrylates for UV curable materials. The inventors have synthesized a special type of polyether (meth)acrylates which is not available in the present market, that is, isocyanurate-glycerol based polyether (meth)acrylates. Compared with present polyethers in the market which are mostly aliphatic polyol based, isocyanurate-glycerol based polyethers have rigid isocyanurate structure, endowing the material extra strength and thermal stability. The triethanolamine unit in isocyanurate-glycerol-triethanolamine polyether (meth)acrylates endows the material with anti-oxygen inhibition property in UV curing process. The isocyanurate-glycerol based polyether (meth)acrylates have low viscosity and high reactivity towards UV cure. The cured resins have high resilience and strength. Thus, isocyanurate-glycerol based polyether (meth)acrylates will have wide applications in UV curable adhesives, coatings, inks, sealants, paints, 3D printing. The applications are literally unlimited.

The present disclosure mainly includes three key discoveries: 1) the unique method for the synthesis of trifunctional cyanurate-glycerol-poly(propylene oxide) polyether polyols (CGPE, Examples 4, 5, 6 below), 2) synthesis of polyether (meth)acrylates including cyanurate-glycerol-poly(propylene oxide) polyether (meth)acrylates through transesterification (Examples 7, 8, 9 below), synthesis of polyether (meth)acrylates including cyanurate-glycerol-poly(propylene oxide) polyether acrylates through direct esterification (Examples 10, 11, 12 below).

The process may be described by Scheme 1 shown below.

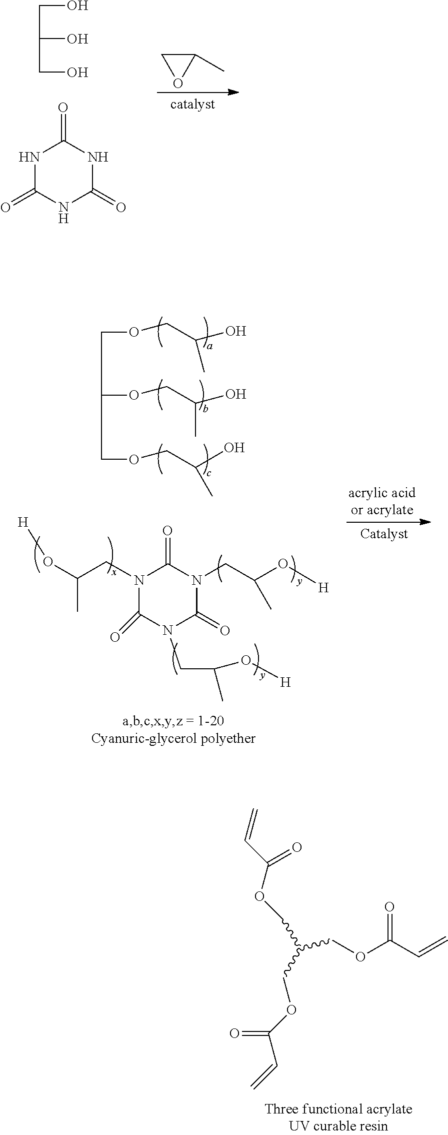

Scheme 1 shows the synthesis of cyanuric-glycerol polyether and three functional acrylate UV curable resin.

The following non-limiting examples give some detailed description of the disclosure, but the scope of the disclosure cannot be limited in the examples.

### Example 1

### Preparation of 2% KOH-Glycerol (Based on OH Group on Glycerol) Initiation Mixture

8.60 g 85% potassium hydroxide was dissolved in 15.00 g distilled water, and then mixed with 200.0 g glycerol in a flask. The mixture is evaporated to remove water through rotary evaporator. The obtained mixture was used for the synthesis of poly (propylene oxide) with different KOH contents.

### Example 2

The Production of Glycerol Poly(Propylene Oxide) Ether Polyol-500 (GPE500) 500 g/mol).

6.500 g of the above prepared glycerol-KOH solution and 6.500 g glycerol are added into a parr pressure reactor. The reactor was evacuated and purged with nitrogen several times. Then the reactor heated to around 100° C. 57.75 g propylene oxide is added into the reactor using a pump with the flow rate of 2 ml/min. After that, the reaction temperature is kept at 125° C. for 15 min before cooling down to room temperature. Unreacted propylene oxide was removed by high vacuum evacuation at 35° C. for 2 hours, under 0.10 g loss was found, showing complete conversion of propylene oxide.

### Example 3

### Production of 25% (Mol) Sucrose-Glycerol Poly(Propylene Oxide) Ether Polyol-600 (SGPE600)

11.12 g sucrose, 8.70 g glycerol-KOH solution and 0.500 g glycerol are added into a batch reactor. Nitrogen is used to remove the air in the reactor for three times. Then 20.00 g propylene oxide is added into reactor though a pump and the reaction temperature is increased to around 90° C. for 30 mins. After that, the reaction temperature is increased to around 120 to 130° C. with the addition of 42.60 g propylene oxide at a flow rate of 2 ml/min. The reaction temperature is kept at 130° C. for 30 mins before cooling down to room temperature. Complete conversion of propylene oxide was achieved.

### Example 4

### Production of 3/7 (Mol) Cyanuric-Glycerol Poly(Propylene Oxide) Ether Polyol-500 (CGPE-500).

6.58 g cyanuric acid, 4.10 g of the above prepared glycerol-KOH solution and 7.20 glycerol are added into a batch reactor. Nitrogen was used to remove the air in the reactor for three times and then the reaction temperature was increased to around 120 to 130° C. Next, the 67.27 g propylene oxide was added into the reactor using a pump with the flow rate of 2 ml/min. The reaction temperature was kept at 130° C. for 60 mins before cooling down to room temperature. Complete conversion of propylene oxide was achieved.

### Example 5

### Production of 3/7 (Mol) Cyanuric-Glycerol Poly(Propylene Oxide) Ether Polyol-500 (CGPE-500) Using 1,3,5-Tris(2-Hydroxyethyl)Cyanuric Acid and Glycerol as Starter.

11.75 g 1,3,5-Tris(2-hydroxyethyl)cyanuric acid, 3.60 g of the above prepared glycerol-KOH solution and 6.20 glycerol are added into a batch reactor. Nitrogen was used to remove the air in the reactor for three times and then the reaction temperature was increased to around 120 to 130° C. Next, the 53.50 g propylene oxide was added into the reactor using a pump with the flow rate of 2 ml/min. The reaction temperature was kept at 130° C. for 60 mins before cooling down to room temperature. Complete conversion of propylene oxide was achieved.

### Example 6

Production of (1/3/6 Mol) Triethanolamine-Cyanuric Acid-Glycerol Poly(Propylene Oxide) Ether Polyol TEACGPE 800 g/Mol

1.60 g triethanolamine, 4.14 g cyanuric acid, 2.60 g glycerol-KOH solution and 3.50 glycerol were added into a batch reactor. Nitrogen was used to remove the air in the reactor for three times and then the reaction temperature was increased to around 120 to 130° C. Then, 73.83 g propylene oxide was added into the reactor using a pump with at the flow rate of 2 ml/min. After that, the reaction temperature was kept at 130° C. for 60 mins before cooling down to room temperature. Complete conversion of propylene oxide was achieved.

### Example 7

Synthesis of Trifunctional CGPE Acrylate Through Transesterification with Ethyl Acrylate (EA)

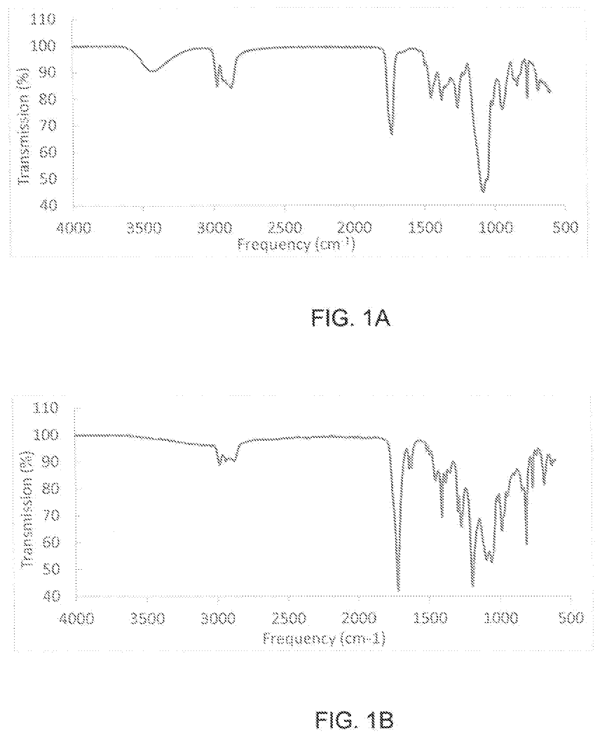

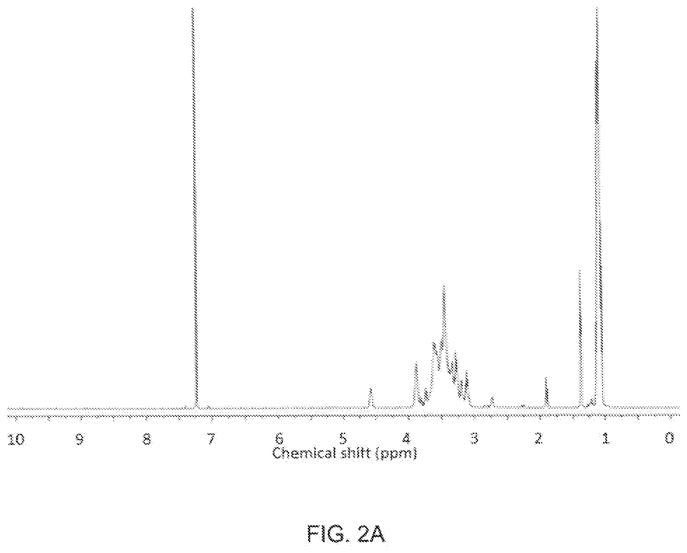

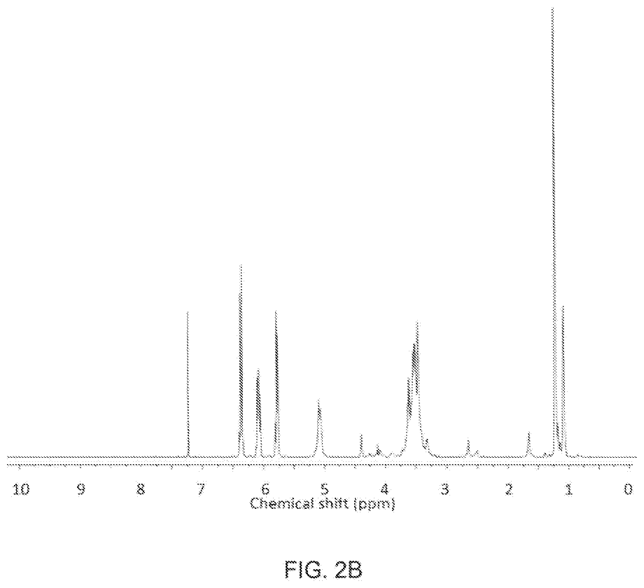

In a 300 mL three-neck flask, one neck was equipped with a pressure balanced addition funnel with a condenser and bubbler on the top. The funnel was filled with 4A molecular sieves. The other two necks were connected with a nitrogen inlet and a thermometer. 60.00 g of the above polyether polyol (molecular weight 500 g/mol) was added, followed by 10.00 g dioxane, 0.35 g titanium tetrachloride, the mixture was stirred for 15 min under nitrogen flow. Then 0.2 g phenothiazine (PTZ) was added, followed by 72.00 g of EA. The mixture was purged with nitrogen for 15 min, then was refluxed at in a 115° C. oil bath with magnetic stirring for 8 hours. After cooling to room temperature, the reaction mixture was diluted with dichloromethane, centrifuged. The solvent and unreacted EA in liquid mixture was removed in a rotary evaporator under vacuum, left the product polyether acrylate in the distillation flask. EA and dioxane as a mixture which can be reused as feedstock for the next reaction was recovered by removing dichlormethane by fractional distillation. The FTIR spectra shown in FIGS. 1A and 1B and the NMR spectra shown in FIGS. 2A and 2B show almost complete conversion of the hydroxyl groups to acrylate groups. More particularly, in the FTIR spectrum shown in FIG. 1A, the broad peak at 3400 cm⁻¹ is the hydroxyl group in cyanuric polyether polyol. In the FTIR spectrum of the acrylation product shown in FIG. 1B, the hydroxyl group is completely converted to acrylate group which shows a strong peak at 1720 cm⁻¹ which is the carbonyl group of acrylate overlapped with the carbonyl group of isocyanuric ring. In the proton NMR shown in FIG. 2A, the peak at 3.8 ppm disappeared after acrylation, and the new three strong peaks between 5.5 and 6.5 ppm in FIG. 2B prove the presence of three protons attached to C═C double bond of the acrylate.

### Example 8

Synthesis of Trifunctional CGPE Acrylate Through Transesterification with Methyl Acrylate (MA)

In a 300 mL three-neck flask, one neck was equipped with a pressure balanced addition funnel with a condenser and bubbler on the top. The funnel was filled with 4A molecular sieves. The other two necks were connected with a nitrogen inlet and a thermometer. 60.00 g of the above polyether polyol (molecular weight 500 g/mol) was added, followed by 15.00 g ethylene diethyl ether, 0.25 g titanium tetrachloride, the mixture was stirred for 15 min under nitrogen flow. Then 0.5 g diethylhydroxylamine, 0.1 g phenothiazine (PTZ) was added, followed by 62.00 g of MA. The mixture was purged with nitrogen for 15 min, then was refluxed in a 110° C. oil bath with magnetic stirring for 8 hours. After cooling to room temperature, the reaction mixture was diluted with dichloromethane, centrifuged. The solvent and unreacted MA in liquid mixture was removed in a rotary evaporator under vacuum, left the product polyether acrylate in the distillation flask. MA and ethylene diethyl ether as a mixture which can be reused as feedstock for the next reaction was recovered by removing dichlormethane by fractional distillation. FTIR spectrum shows almost complete conversion of the hydroxyl groups to acrylate groups.

### Example 9

Synthesis of Trifunctional CGPE Acrylate Through Transesterification with Methyl Acrylate (MA)

In a 250 mL three-neck flask, one neck was equipped with a fractional column with Dean Stark, a condenser and bubbler sequentially on the top. The dean Stark was filled with a solution of 0.5% diethylhydroxylamine in hexanes. The fractional column is filled with glass spring. The other two necks were connected with a nitrogen inlet and a thermometer. 60.00 g of the above polyether polyol (molecular weight 500 g/mol) was added, followed by 5.00 g hexanes, 15.00 g ethylene diethyl ether, 0.25 g titanium tetrachloride, the mixture was stirred for 15 min under nitrogen flow. Then 0.1 g phenothiazine (PTZ) was added, followed by 62.00 g of MA. The mixture was purged with nitrogen for 15 min, then was refluxed in a 110° C. oil bath with magnetic stirring for 8 hours. After cooling to room temperature, the reaction mixture was diluted with dichloromethane, centrifuged. The solvent and unreacted MA in liquid mixture was removed in a rotary evaporator under vacuum, left the product polyether acrylate in the distillation flask. MA and ethylene diethyl ether as a mixture which can be reused as feedstock for the next reaction was recovered by removing dichlormethane by fractional distillation. FTIR spectrum shows almost complete conversion of the hydroxyl groups to acrylate groups.

### Example 10

Synthesis of Trifunctional CGPE Acrylate Through Direct Esterification with Acrylic Acid (AA)

In a 300 mL three-neck flask, one neck was equipped with a fractional column with a Dean Stark, a condenser, and bubbler on the top. The Dean Stark was filled with butylated hydroxyl toluene dissolved in cyclohexane. The other two necks were connected with a gas inlet and a thermometer. 60.00 g of the polyether polyol (molecular weight 500 g/mol) was added, followed by 20.00 g cyclohexane, 1.0 g methyl hydroquinone, 3.0 g toluenesulfonic acid, and 52.0 g acrylic acid. The mixture was refluxed in a 110° C. oil bath with magnetic stirring for 6 hours at 2 ml/min air flow. After cooling to room temperature, the reaction mixture was diluted with dichloromethane, neutralized with potassium carbonate, and centrifuged. The solvent and unreacted AA in liquid mixture was removed in a rotary evaporator under vacuum, left the product polyether acrylate in the distillation flask. AA and cyclohexane as a mixture which can be reused as feedstock for the next reaction was recovered by removing dichlormethane by fractional distillation. FTIR spectrum shows almost complete conversion of the hydroxyl groups to acrylate groups.

### Example 11

Synthesis of Trifunctional CGPE Acrylate Through Direct Esterification with Acrylic Acid (AA)

In a 300 mL three-neck flask, one neck was equipped with a fractional column with a Dean Stark, a condenser, and bubbler on the top. The Dean Stark was filled with phenothiazine dissolved in cyclohexane. The other two necks were connected with a gas inlet and a thermometer. 60.00 g of the polyether polyol (molecular weight 500 g/mol) was added, followed by 20.00 g cyclohexane, 0.1 g phenothiazine, 3.0 g toluenesulfonic acid, and 52.0 g acrylic acid. The mixture was refluxed in a 110° C. oil bath with magnetic stirring for 6 hours at 2 ml/min nitrogen flow. After cooling to room temperature, the reaction mixture was diluted with dichloromethane, neutralized with potassium carbonate, and centrifuged. The solvent and unreacted AA in liquid mixture was removed in a rotary evaporator under vacuum, left the product polyether acrylate in the distillation flask. AA and cyclohexane as a mixture which can be reused as feedstock for the next reaction was recovered by removing dichlormethane by fractional distillation. FTIR spectrum shows almost complete conversion of the hydroxyl groups to acrylate groups.

### Example 12

Synthesis of Trifunctional CGPE Acrylate Through Direct Esterification with Acrylic Acid (AA)

In a 300 mL three-neck flask, one neck was equipped with a fractional column with a Dean Stark, a condenser, and bubbler on the top. The Dean Stark was filled with phenothiazine dissolved in cyclohexane. The other two necks were connected with a gas inlet and a thermometer. 60.00 g of the polyether polyol (molecular weight 500 g/mol) was added, followed by 20.00 g cyclohexane, 0.1 g phenothiazine, 10.00 g Amberlyst 15, and 52.0 g acrylic acid. The mixture was refluxed in a 110° C. oil bath with magnetic stirring for 6 hours at 2 ml/min nitrogen flow. After cooling to room temperature, the reaction mixture was diluted with dichloromethane, filtered. The Amberlyst can be reused. The solvent and unreacted AA in liquid mixture was removed in a rotary evaporator under vacuum, left the product polyether acrylate in the distillation flask. AA and cyclohexane as a mixture which can be reused as feedstock for the next reaction was recovered by removing dichlormethane by fractional distillation. FTIR spectrum shows almost complete conversion of the hydroxyl groups to acrylate groups. The synthesized poly(propylene oxide) polyether acrylates have a viscosity range of 100 cP to 200 cP, so they can be used directly as UV curing materials. Examples 6-11 for the synthesis of polyether acrylates can apply for all the polyether polyols synthesized in examples 1-5.

### Example 13

### UV Curing of Poly(Propylene Oxide) Polyether Acrylates

Various of poly(propylene oxide) polyether acrylates were mixed with 3% UV initiator 2-Hydroxy-2-methylpropiophenone (Daracure 1173, or 1173) and cured under 600 watt UN light. The results show that polyether acrylate products with isocyanurate unit having higher strength, and triethanolamine provides anti-oxygen inhibition effect. (no data).

The foregoing description of the preferred embodiments of the disclosure has been presented to illustrate the principles of the disclosure and not to limit the disclosure to the particular embodiment illustrated. It is intended that the scope of the disclosure be defined by all of the embodiments encompassed within the following claims and their equivalents.

Therefore what is claimed is:

1. A multifunctional polyether polyol which is a polymerization product of:
cyanuric acid or substituted cyanuric acid,
multifunctional alcohol, and
propylene oxide.

2. The polyether polyol according to claim 1, wherein the substituted cyanuric acid is 1,3,5-Tris(2-hydroxyethyl)cyanuric acid.

3. The polyether polyol according to claim 1, having the following general formula: 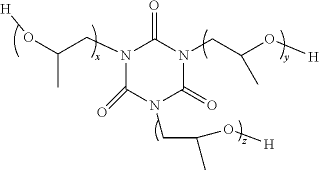
wherein each of x, y, and z is independently 1 to 20.

4. The polyether polyol according to claim 1, wherein the polymerization product further includes triethanolamine units.

5. The polyether polyol according to claim 1, having a molecular weight of 300-2000 g/mol.

6. A polymer which is an esterified product of (i) the polyether polyol according to a claim 1; and (ii) any one or a combination of acrylic acid, methacrylic acid, acrylate and methacrylate.

7. The polymer according to claim 6, wherein the acrylate is ethyl acrylate or methyl acrylate, and the methacrylate is methyl methacrylate or ethyl methacrylate.

8. A UV curable composition comprising the polymer of claim 6.

9. The composition according to claim 8, for use in any one of coatings, adhesives, paints, printing inks, and 3D printing.

10. A method of preparing a trifunctional polyether polyol, the method comprising:
mixing monomers in a reactor in the presence of a catalyst to obtain a mixture of the monomers, wherein the monomers in the mixture comprise cyanuric acid or substituted cyanuric acid, multifunctional alcohol, and propylene oxide; and
polymerizing the monomers in the reactor to produce the trifunctional polyether polyol.

11. The method according to claim 10, wherein the monomers further comprise triethanolamine.

12. The method according to claim 11, wherein the cyanuric acid or the substituted cyanuric acid is in the amount of 0-60 mol %, and the triethanolamine is in the amount of 0-20 mol %.

13. The method according to claim 10, wherein the multifunctional alcohol is glycerol or sucrose.

14. The method according to claim 10, wherein the catalyst is an alkaline catalyst.

15. The method according to claim 14, wherein the alkaline catalyst is potassium hydroxide or sodium hydroxide.

16. The method according to claim 10, wherein the catalyst is present in a concentration of about 0.1-5 mol % of hydroxyl groups.

17. The method according to claim 16, wherein the concentration of the catalyst is about 0.2-3 mol % of hydroxyl groups.

18. A method of preparing a polyether polyol (meth)acrylate comprising:
adding the multifunctional polyether polyol according to claim 1 into a reactor; and
reacting the trifunctional polyether polyol with an esterification agent in the presence of a catalyst, wherein the esterification agent is selected from the group consisting of acrylic acid, methacrylic acid, low alcohol acrylate, and low alcohol methacrylate.

19. The method according to claim 18, wherein the polyether polyol is glycerol isocyanurate poly(propylene oxide) polyether polyol, glycerol-triethanolamine-isocyanurate poly(propylene oxide) polyether polyols, sucrose-glycerol poly(propylene oxide) polyether polyols, sucrose-glycerol-triethanolamine poly(propylene oxide) polyether polyols.

20. The method according to claim 18, wherein the esterification agent used in the reacting step is low alcohol acrylate or low alcohol methacrylate, selected from the group consisting of methyl acrylate, ethyl acrylate, methyl methacrylate and ethyl methacrylate.

21. The method according to claim 20, wherein the catalyst is titanium tetrachloride (TiCl₄) or titanium tetraiosproppoxide (TiTIP).

22. The method according to claim 21, wherein TiCl₄ is in a concentration of about 0.1-2 wt % and TiTIP is in a concentration of about 0.1-2 wt %.

23. The method according to claim 18, further including a step of recycling the catalyst for a next reaction without sacrifice their activity.

24. The method according to claim 20, wherein the ratio of the esterification agent and hydroxyl groups in the polyether polyol is about 1.0-5.0:1.

25. The method according to claim 24, wherein the ratio is about 1.2-2.5:1.

26. The method according to claim 20, further comprising adding a solvent wherein the solvent is any one or a combination of a hydrocarbon solvent and an ether solvent.

27. The method according to claim 26, wherein the hydrocarbon solvent is any one of hexanes, cyclohexane, heptane, octane and toluene, and the ether solvent is any one of dioxane, dimethyl ethylene glycol ether, diethyl ethylene glycol ether, and dimethyl propylene glycol ether.

28. The method according to claim 20, further comprising a step of removing by-product methanol or ethanol.

29. The method according to claim 28, wherein the removing step is carried out by molecular sieves or azeotropic distillation.

30. The method according to claim 20, further comprising a step of adding an inhibitor for polymerization of the esterification agents.

31. The method according to claim 30, wherein the inhibitor is any one or a combination of phenothiazine, methyl hydroquinone (MEDQ), diethylhydroxylamine and nitrosobenzene.

32. The method according to claim 18, wherein the esterification agent used in the reacting step is acrylic acid or methacrylic acid.

33. The method according to claim 32, wherein the catalyst is organosulfonic acid.

34. The method according to claim 33, wherein the organosulfonic acid is any one of toluenesulfonic acid, methanesulfonic acid, and sulfonic based ionic exchange resins.

35. The method according to claim 34, wherein the toluenesulfonic acid or the mathanesulfonic acid is added in a concentration of about 0.1-3 wt %.

36. The method according to claim 34, wherein the sulfonic based ionic exchange resins is added in a concentration of about 2-30 wt %.

37. The method according to claim 32 further comprising a step of adding a polymerization inhibitor and/or a water-azeotropic solvent.

38. The method according to claim 37, wherein the polymerization inhibitor is a phenolic antioxidant or phenothiazine.

39. The method according to claim 38, wherein the phenolic antioxidant is methyl hydroquinone (MEHQ) or butylate hydroxytoluene (BHT).

40. The method according to claim 38, wherein the phenolic antioxidant is added in a concentration of about 100-10,000 ppm and the phenothiazine is added in a concentration of about 100-5,000 ppm.

41. The method according to claim 37, wherein the polymerization inhibitor is added to a Dean Stark to prevent advent polymerization on a fractional column.

42. The method according to claim 37, wherein the solvent is any one or a combination of a hydrocarbon and chlorinate hydrocarbon.

43. The method according to claim 42, wherein the hydrocarbon is hexanes, cyclohexane or heptane, and the chlorinate hydrocarbon is 1,2-dichloroethane, 1,1-dichlorethane or chloroform.

44. The polyether polyol according to claim 10, wherein the substituted cyanuric acid is 1,3,5-Tris(2-hydroxyethyl)cyanuric acid.

45. The method according to claim 16, wherein the multifunctional polyether polyol is a trifunctional polyether polyol.

46. The polyether polyol according to claim 1, wherein the multifunctional alcohol is glycerol or sucrose.
